(19) United States
(12) Patent Application Publication
(10) Pub. No.: US 2019/0286711 A1
(43) Pub. Date: Sep. 19, 2019

(54) SYSTEMS AND METHODS FOR MESSAGE BUILDING FOR MACHINE LEARNING CONVERSATIONS

(71) Applicant: Conversica, Inc., Foster City, CA (US)

(72) Inventors: George Alexis Terry, Woodside, CA (US); James D. Harriger, Duvall, WA (US); Werner Koepf, Seattle, WA (US); Siddhartha Reddy Jonnalagadda, Bothell, WA (US); William Dominic Webb-Purkis, San Francisco, CA (US); Macgregor S. Gainor, Bellingham, WA (US); Patrick D. Griffin, Bellingham, WA (US)

(21) Appl. No.: 16/365,663

(22) Filed: Mar. 26, 2019

Related U.S. Application Data
(63) Continuation-in-part of application No. 16/019,382, filed on Jun. 26, 2018.
Application No. 16/019,382 is a continuation-in-part of application No. 14/604,610, filed on Jan. 23, 2015, now Pat. No. 10,026,037.
Application No. 14/604,610 is a continuation-in-part of application No. 14/604,602, filed on Jan. 23, 2015.
Application No. 14/604,602 is a continuation-in-part of application No. 14/604,594, filed on Jan. 23, 2015.
(60) Provisional application No. 62/649,507, filed on Mar. 28, 2018.

(51) Int. Cl. G06F 17/28; G06F 17/27; H04L 12/58; G06N 20/00; G06F 17/24

(52) U.S. Cl. CPC G06F 17/2881; G06F 17/277; G06F 17/278; G06F 17/248; G06N 20/00; G06F 17/243; H04L 51/02

(57) ABSTRACT

Systems and methods for variable field replacement are provided. Message templates include variable fields that can be populated with industry and client specific information through entity replacement, lexical replacement and phrase package selection. In addition to the generation of messages, the system may also be able to perform other actions that leverage external third-party systems. The templates may be drawn from a conversation library with hierarchical inheritance. Likewise, actions may leverage an action response library that links triggers in the response to required actions. Packet selection is based upon how closely the phrase fits a personality for the AI identity, and how well historically the phrase has performed. Lastly, while the AI systems disclosed herein have the ability to understand and respond to conversations in natural language format, this is computationally expensive. These AI systems may use an objective and intent based communication protocol when communicating with one another.

### CROSS REFERENCE TO RELATED APPLICATIONS

This continuation-in-part application is a non-provisional and claims the benefit of U.S. provisional application entitled “Systems and Methods for Enhanced Natural Language Processing for Machine Learning Conversations,” U.S. provisional application No. 62/649,507, Attorney Docket No. CVSC-18E-P, filed in the USPTO on Mar. 28, 2018, currently pending.

This continuation-in-part application also claims the benefit of U.S. application entitled “Systems and Methods for Natural Language Processing and Classification,” U.S. application Ser. No. 16/019,382, Attorney Docket No. CVSC-17A1-US, filed in the USPTO on Jun. 26, 2018, pending, which is a non-provisional of U.S. provisional application No. 62/561,194, Attorney Docket No. CVSC-17A-P, filed in the USPTO on Sep. 20, 2017, of the same title. U.S. application Ser. No. 16/019,382 also is a continuation-in-part application which claims the benefit of U.S. application entitled “Systems and Methods for Configuring Knowledge Sets and AI Algorithms for Automated Message Exchanges,” U.S. application Ser. No. 14/604,610, Attorney Docket No. CVSC-1403, filed in the USPTO on Jan. 23, 2015, now U.S. Pat. No. 10,026,037 issued Jul. 17, 2018. Additionally, U.S. application Ser. No. 16/019,382 claims the benefit of U.S. application entitled “Systems and Methods for Processing Message Exchanges Using Artificial Intelligence,” U.S. application Ser. No. 14/604,602, Attorney Docket No. CVSC-1402, filed in the USPTO on Jan. 23, 2015, pending, and U.S. application entitled “Systems and Methods for Management of Automated Dynamic Messaging,” U.S. application Ser. No. 14/604,594, Attorney Docket No. CVSC-1401, filed in the USPTO on Jan. 23, 2015, pending.

This application is also related to co-pending and concurrently filed in the USPTO on Mar. 26, 2019, U.S. application Ser. No. ______, entitled “Systems and Methods for Phrase Selection for Machine Learning Conversations”, Attorney Docket No. CVSC-18E2-US and U.S. application Ser. No. ______, entitled “Systems and Methods for Enhanced Natural Language Processing for Machine Learning Conversations”, Attorney Docket No. CVSC-18E3-US.

All of the above-referenced applications/patents are incorporated herein in their entirety by this reference.

### BACKGROUND

The present invention relates to systems and methods for enhanced natural language processing and generation of more “human” sounding artificially generated conversations. Such natural language processing techniques may be employed in the context of machine learned conversation systems. These conversational AIs include, but are not limited to, message response generation, AI assistant performance, and other language processing, primarily in the context of the generation and management of a dynamic conversations. Such systems and methods provide a wide range of business people more efficient tools for outreach, knowledge delivery, automated task completion, and also improve computer functioning as it relates to processing documents for meaning. In turn, such system and methods enable more productive business conversations and other activities with a majority of tasks performed previously by human workers delegated to artificial intelligence assistants.

Artificial Intelligence (AI) is becoming ubiquitous across many technology platforms. AI enables enhanced productivity and enhanced functionality through “smarter” tools. Examples of AI tools include stock managers, chatbots, and voice activated search-based assistants such as Sin and Alexa. With the proliferation of these AI systems, however, come challenges for user engagement, quality assurance and oversight.

When it comes to user engagement, many people do not feel comfortable communicating with a machine outside of certain discrete situations. A computer system intended to converse with a human is typically considered limiting and frustrating. This has manifested in a deep anger many feel when dealing with automated phone systems, or spammed, non-personal emails.

These attitudes persist even when the computer system being conversed with is remarkably capable. For example, many personal assistants such as Siri and Alexa include very powerful natural language processing capabilities; however, the frustration when dealing with such systems, especially when they do not “get it” persists. Ideally an automated conversational system provides more organic sounding messages in order to reduce this natural frustration on behalf of the user. Indeed, in the perfect scenario, the user interfacing with the AI conversation system would be unaware that they are speaking with a machine rather than another human.

It is therefore apparent that an urgent need exists for advancements in the natural language processing techniques used by AI conversation systems. Such systems and methods allow for improved conversations and for added functionalities.

### SUMMARY

To achieve the foregoing and in accordance with the present invention, systems and methods for improved natural language processing are provided. Such systems and methods allow for more effective AI operations, improvements to the experience of a conversation target, and increased productivity through AI assistance.

In some embodiments, systems and methods are provided for variable field replacement when generating a message for a conversation between a target and an Artificial Intelligence (AI) messaging system. Message templates include variable fields that can be populated with industry and client specific information through entity replacement. This entity replacement is responsive to the customer, industry and information related to the target. In addition to entity replacement (names, facts, etc.) lexical replacement may occur to make the message more ‘in line’ with expectations and jargon of the industry.

In some embodiments, responses to the messages can be received, classified, and objectives for the conversation may be updated. Word choices may be responsive to these objective states as well. In addition to the generation of messages, the system may also be able to perform other actions that leverage external third-party systems. These actions may include, for example, sending an attachment, transacting a purchase/contract, pre-populating forms, updating Salesforce, or other data structure, and updating calendars.

The templates may be drawn from a conversation library with hierarchical inheritance. Likewise, actions may leverage an action response library that links triggers in the response to required actions.

In addition to basic entity and word replacement, the system may also be capable of performing phrase packet selection. Packet selection may be based upon how closely the phrase fits a personality for the AI identity, and how well historically the phrase has performed. Performance may be measured based upon how often a message containing the phrase was responded to, and how often the response completed a given objective for the conversation. This raw performance score may be augmented by a padding that ensures that only once sufficient numbers of messages containing the phrase have been sent does the phrase response significantly impact the augmented performance score. The fit of personality and performance may be combined to determine which phrase to user for a given message. In some cases, a randomizing element is also incorporated to maintain so degree of added variability in which phrases are used.

Lastly, as AI based identities proliferate the likelihood that these systems will interact over traditional communication channels increases. Traditional communication channels include email, telephone, SMS messaging, and video conferencing. While the AI systems disclosed herein have the ability to understand and respond to conversations in natural language format, the acts of classifying such messages, and responding appropriately, are major computational resource expenditures. It is far more efficient for these AI systems to recognize that they are ‘speaking’ with another machine and adopt more efficient communication protocols. To that end, the messages sent form an AI may have metadata, or some sort of embedded identifier that is not perceptible to humans, yet still allows the receiving AI system to recognize that it is communicating with another AI. Upon detection of such an identifier the communication may revert to an objective and intent based communication protocol that eliminated the need for phrase selections (or other lengthy language generation), and on the receiving end eliminates much of the need for classification.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example logical diagram of a system for generation and implementation of messaging conversations, in accordance with some embodiment;

FIG. 2 is an example logical diagram of a dynamic messaging server, in accordance with some embodiment;

FIG. 3 is an example logical diagram of a user interface within the dynamic messaging server, in accordance with some embodiment;

FIG. 4 is an example logical diagram of a message generator within the dynamic messaging server, in accordance with some embodiment;

FIG. 5A is an example logical diagram of a message response system within the dynamic messaging server, in accordance with some embodiment;

FIG. 5B is an example logical diagram of a dynamic message system, in accordance with some embodiment;

FIG. 5C is an example logical diagram of a message delivery handler, in accordance with some embodiment;

FIG. 6 is an example flow diagram for a dynamic message conversation, in accordance with some embodiment;

FIG. 7 is an example flow diagram for the process of on-boarding a business actor, in accordance with some embodiment;

FIG. 8 is an example flow diagram for the process of building a business activity such as conversation, in accordance with some embodiment;

FIG. 9 is an example flow diagram for the process of generating message templates, in accordance with some embodiment;

FIG. 10 is an example flow diagram for the process of implementing the conversation, in accordance with some embodiment;

FIG. 11 is an example flow diagram for the process of preparing and sending the outgoing message, in accordance with some embodiment;

FIG. 12 is an example flow diagram for the process of processing received responses, in accordance with some embodiment;

FIG. 13 is an example flow diagram for the process of document cleaning, in accordance with some embodiment;

FIG. 14 is an example flow diagram for message classification and response, in accordance with some embodiment;

FIG. 15 is an example flow diagram for event categorization and response, in accordance with some embodiment;

FIG. 16 is an example flow diagram for the generation of a response message, in accordance with some embodiment;

FIG. 17 is an example flow diagram for the process template variable field population, in accordance with some embodiment;

FIG. 18 is an example flow diagram for the process of action execution, in accordance with some embodiment;

FIG. 19 is an example illustration of a configurable AI assistant within a conversation system, in accordance with some embodiment; and

FIGS. 20A and 20B are example illustrations of a computer system capable of embodying the current invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to enhancements to traditional natural language processing techniques. While such systems and methods may be utilized with any AI system, such natural language processing particularly excel in AI systems relating to the generation of automated messaging for business conversations such as marketing and other sales functions. While the following disclosure is applicable for other combinations, we will focus upon natural language processing in AI marketing systems as an example, to demonstrate the context within which the enhanced natural language processing excels.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

The following systems and methods are for improvements in natural language processing, within conversation systems, and for employment of domain specific assistant systems that leverage these enhanced natural language processing techniques. The goal of the message conversations is to enable a logical dialog exchange with a recipient, where the recipient is not necessarily aware that they are communicating with an automated machine as opposed to a human user. This may be most efficiently performed via a written dialog, such as email, text messaging, chat, etc. However, given the advancement in audio and video processing, it may be entirely possible to have the dialog include audio or video components as well.

In order to effectuate such an exchange, an AI system is employed within an AI platform within the messaging system to process the responses and generate conclusions regarding the exchange. These conclusions include calculating the context of a document, intents, entities, sentiment and confidence for the conclusions. Human operators cooperate with the AI to ensure as seamless an experience as possible, even when the AI system is not confident or unable to properly decipher a message. The natural language techniques disclosed herein assist in making the outputs of the AI conversation system more effective, and more ‘human sounding’, which may be preferred by the recipient/target of the conversation.

### I. Dynamic Messaging Systems with Enhanced Natural Language Processing

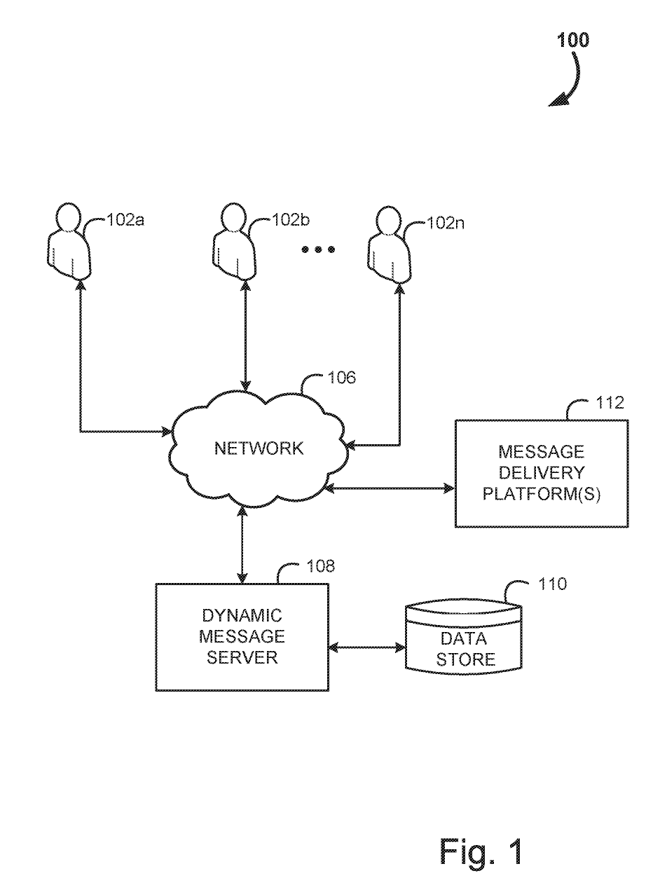

To facilitate the discussion, FIG. 1 is an example logical diagram of a system for generating and implementing messaging conversations, shown generally at 100. In this example block diagram, several users 102a-n are illustrated engaging a dynamic messaging system 108 via a network 106. Note that messaging conversations may be uniquely customized by each user 102a-n in some embodiments. In alternate embodiments, users may be part of collaborative sales departments (or other collaborative group) and may all have common access to the messaging conversations. The users 102a-n may access the network from any number of suitable devices, such as laptop and desktop computers, work stations, mobile devices, media centers, etc.

The network 106 most typically includes the internet but may also include other networks such as a corporate WAN, cellular network, corporate local area network, or combination thereof, for example. The messaging server 108 may distribute the generated messages to the various message delivery platforms 112 for delivery to the individual recipients. The message delivery platforms 112 may include any suitable messaging platform. Much of the present disclosure will focus on email messaging, and in such embodiments the message delivery platforms 112 may include email servers (Gmail, Yahoo, Outlook, etc.). However, it should be realized that the presently disclosed systems for messaging are not necessarily limited to email messaging. Indeed, any messaging type is possible under some embodiments of the present messaging system. Thus, the message delivery platforms 112 could easily include a social network interface, instant messaging system, text messaging (SMS) platforms, or even audio or video telecommunications systems.

One or more data sources 110 may be available to the messaging server 108 to provide user specific information, message template data, knowledge sets, intents, and target information. These data sources may be internal sources for the system's utilization or may include external third-party data sources (such as business information belonging to a customer for whom the conversation is being generated). These information types will be described in greater detail below.

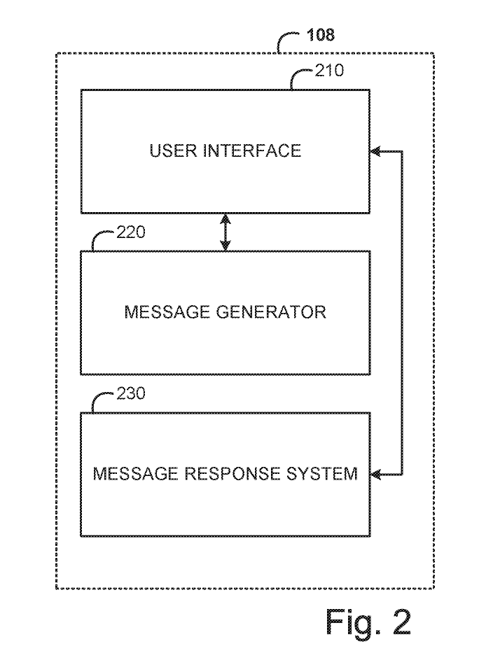

Moving on, FIG. 2 provides a more detailed view of the dynamic messaging server 108, in accordance with some embodiment. The server is comprised of three main logical subsystems: a user interface 210, a message generator 220, and a message response system 230. The user interface 210 may be utilized to access the message generator 220 and the message response system 230 to set up messaging conversations and manage those conversations throughout their life cycle. At a minimum, the user interface 210 includes APIs to allow a user's device to access these subsystems. Alternatively, the user interface 210 may include web accessible messaging creation and management tools.

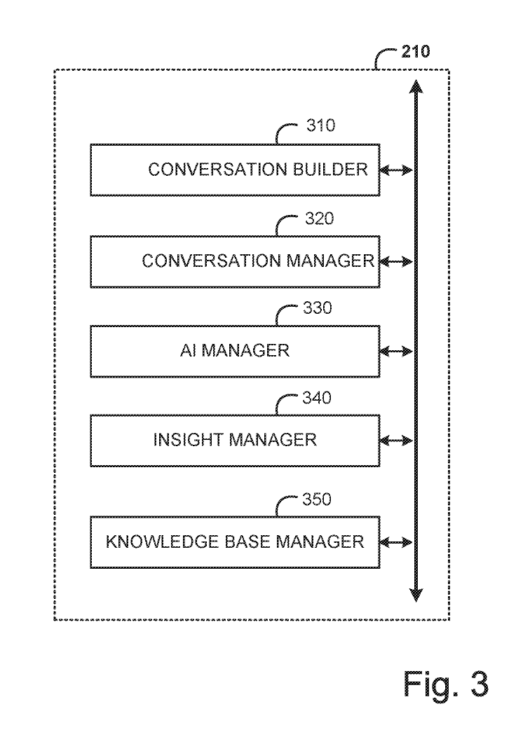

FIG. 3 provides a more detailed illustration of the user interface 210. The user interface 210 includes a series of modules to enable the previously mentioned functions to be carried out in the message generator 220 and the message response system 230. These modules include a conversation builder 310, a conversation manager 320 an AI manager 330, an intent manager 340, and a knowledge base manager 350.

The conversation builder 310 allows the user to define a conversation, and input message templates for each series/exchange within the conversation. A knowledge set and target data may be associated with the conversation to allow the system to automatically effectuate the conversation once built. Target data includes all the information collected on the intended recipients, and the knowledge set includes a database from which the AI can infer context and perform classifications on the responses received from the recipients.

The conversation manager 320 provides activity information, status, and logs of the conversation once it has been implemented. This allows the user 102a to keep track of the conversation's progress, success and allows the user to manually intercede if required. The conversation may likewise be edited or otherwise altered using the conversation manager 320.

The AI manager 330 allows the user to access the training of the artificial intelligence which analyzes responses received from a recipient. One purpose of the given systems and methods is to allow very high throughput of message exchanges with the recipient with relatively minimal user input. To perform this correctly, natural language processing by the AI is required, and the AI (or multiple AI models) must be correctly trained to make the appropriate inferences and classifications of the response message. The user may leverage the AI manager 330 to review documents the AI has processed and has made classifications for.

The intent manager 340 allows the user to manage intents. As previously discussed, intents are a collection of categories used to answer some question about a document. For example, a question for the document could include “is the lead looking to purchase a car in the next month?” Answering this question can have direct and significant importance to a car dealership. Certain categories that the AI system generates may be relevant toward the determination of this question. These categories are the ‘intent’ to the question and may be edited or newly created via the intent manager 340.

In a similar manner, the knowledge base manager 350 enables the management of knowledge sets by the user. As discussed, a knowledge set is a set of tokens with their associated category weights used by an aspect (AI algorithm) during classification. For example, a category may include “continue contact?”, and associated knowledge set tokens could include statements such as “stop”, “do no contact”, “please respond” and the like.

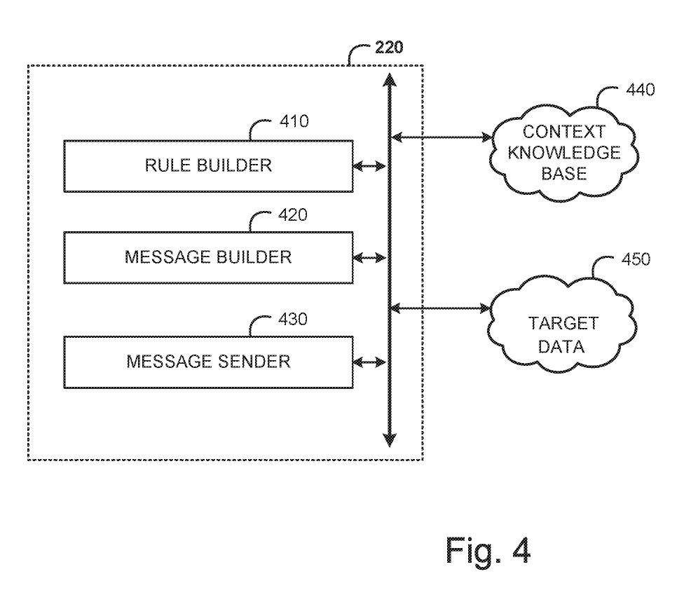

Moving on to FIG. 4, an example logical diagram of the message generator 220 is provided. The message generator 220 utilizes context knowledge 440 and target data 450 to generate the initial message. The message generator 220 includes a rule builder 410 which allows the user to define rules for the messages. A rule creation interface which allows users to define a variable to check in a situation and then alter the data in a specific way. For example, when receiving the scores from the AI, if the intent is Interpretation and the chosen category is ‘good’, then have the Continue Messaging intent return ‘continue’.

The rule builder 410 may provide possible phrases for the message based upon available target data. The message builder 420 incorporates those possible phrases into a message template, where variables are designated, to generate the outgoing message. Multiple selection approaches and algorithms may be used to select specific phrases from a large phrase library of semantically similar phrases for inclusion into the message template. For example, specific phrases may be assigned category rankings related to various dimensions such as “formal vs. informal, education level, friendly tone vs. unfriendly tone, and other dimensions,” Additional category rankings for individual phrases may also be dynamically assigned based upon operational feedback in achieving conversational objectives so that more “successful” phrases may be more likely to be included in a particular message template. Phrase package selection will be discussed in further detail below. The selected phrases incorporated into the template message is provided to the message sender 430 which formats the outgoing message and provides it to the messaging platforms for delivery to the appropriate recipient.

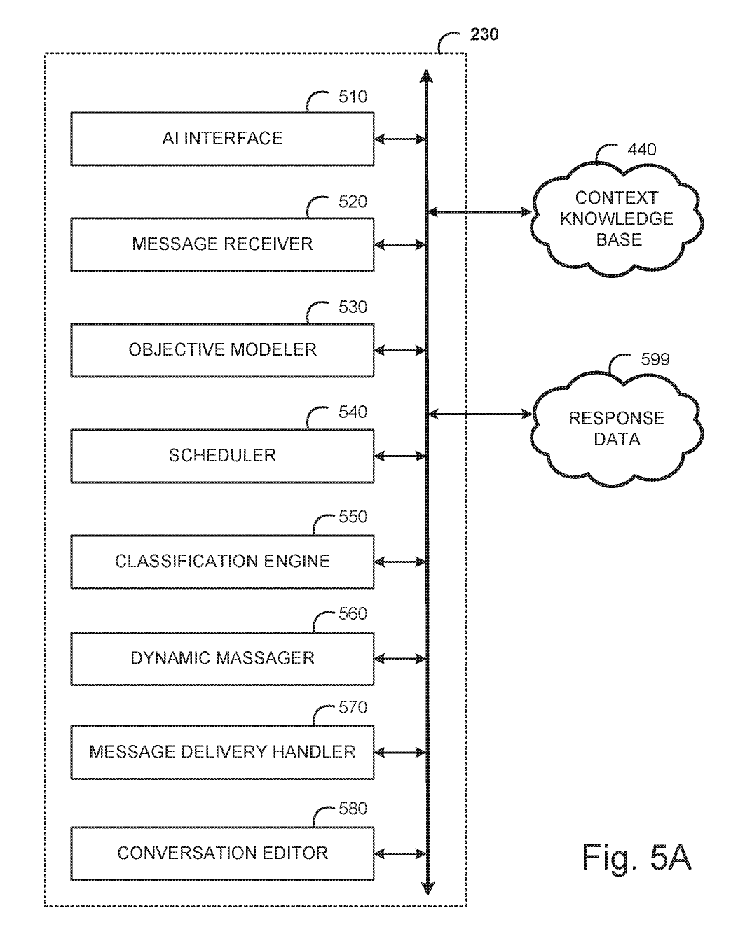

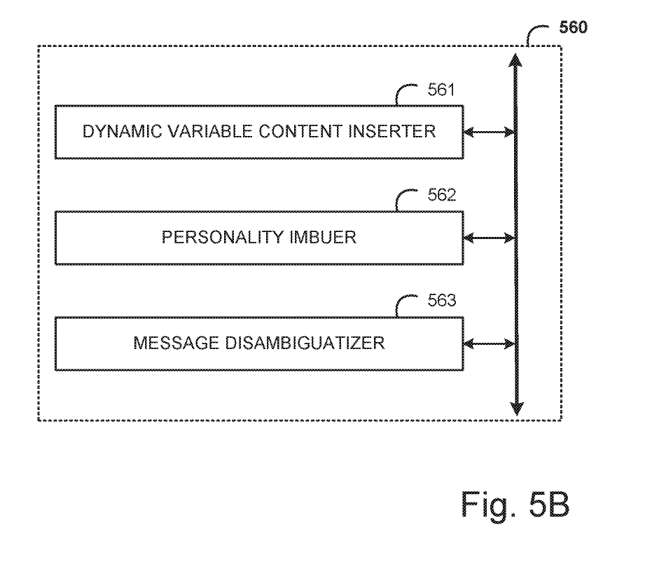

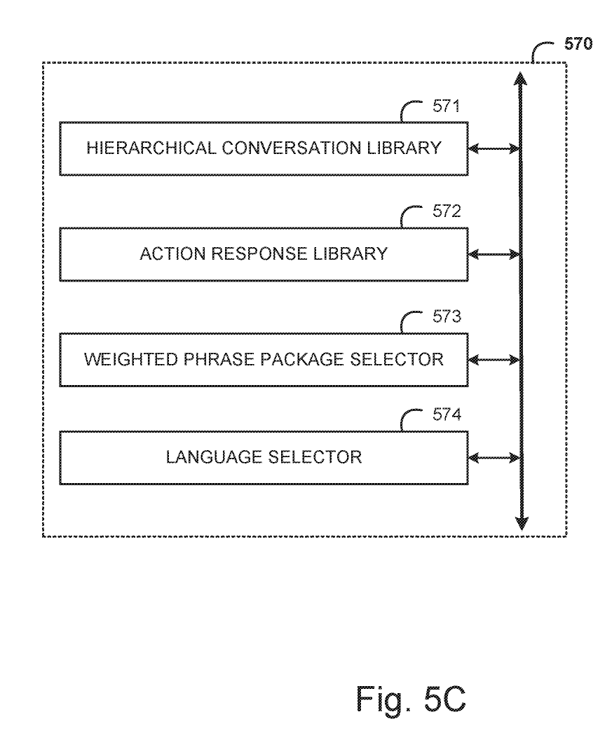

FIG. 5A is an example logical diagram of the message response system 230. In this example system, the contextual knowledge base 440 is utilized in combination with response data 599 received from the person being messaged (the target or recipient). The message receiver 520 receives the response data 599 and provides it to the AI interface 510, objective modeler 530, and classifier engine 550 for feedback. The AI interface 510 allows the AI platform (or multiple AI models) to process the response for context, intents, sentiments and associated confidence scores. The classification engine 550 includes a suite of tools that enable better classification of the messages using machine learned models. Based on the classifications generated by the AI and classification engine 550 tools target objectives may be updated by the objective modeler 530. The objective modeler may indicate what the objective to the next action in the conversation may entail.

The dynamic messager 560 then formulates a response based upon the classification and objectives. Unlike traditional response systems, the dynamic messager 560 allows for more varied responses through variable selection that takes into account success prediction and personality mimicry. The result is a response that is more natural and ‘organic’ sounding, yet composed in a manner most likely to effectuate a particular reaction form the recipient

The message delivery handler 570 enables not only the delivery of the generated responses, but also may effectuate additional actions beyond mere responds delivery. The message delivery handler 570 may include phrase selections, contextualizing the response by historical activity, and through language selection.

Lastly, a conversation editor interface 580 may enable a user of the system to readily understand how the model operates at any given node, and further enables the alteration of how the system reacts to given inputs. The conversation editor 580 may also generate and display important metrics that may assist the user in determining if, and how, a given node should be edited. For example, for a given action at the node, the system may indicate how often that action has been utilized in the past, or how often the message if referred to the training desk due to the model being unclear on how to properly respond. Importantly, the conversation editor 580 may also enable a user of the system to configure AI assistants and manage the personality type for such an assistant.

Turning to FIG. 5B, the dynamic messager 560 is illustrated in greater detail. The dynamic messager 560 allows for variable content to be inserted into a messaging template using a dynamic variable content inserter 561. A message template defines the structure of an outgoing message. A template design can describe the format of all outgoing email messages with one primary template and a secondary informational template. Templates can be stored by ‘template_id’ and ‘name’ in a ‘message_template’ table. An example message template table is provided below at Table 1.

TABLE 1
message template table

| Template ID | Name | Requirement |
|---|---|---|
| 1 | Salutation | 1 |
| 1 | Conversation | 0-1 |
| 1 | Introduction | 0-1 |
| 1 | Information 1 | 0-1 |
| 1 | Question | 1 |
| 1 | Information 2 | 0-1 |
| 1 | Closing | 1 |
| 1 | Post Script | 0-1 |

The example message template table presented in Table 1 is of course merely illustrative; depending upon the message stage in a conversational series, the number and type of components may differ significantly. For example, an introductory message may merely include a salutation, conversation, a single question, and a closing, to determine recipient interest or intent. An informational end message may include multiple possible informational components, but not any additional questions. Such a message may conclude with an invitation to the recipient to contact the system if they have any further questions (otherwise the message series is terminated) for example.

Conversation messages will have as much variation as is described by the individual components. A message with only one phrase defined for each template component can mimic a static message type; however, when each component is compartmentalized, and a library of possible variable entries is developed, the message that may be generated for any given response expands exponentially. Variable content may be selected by a number of methods, including linking specific content packages such that particular language used is commonly paired with other language in a manner that mimics human speech more accurately. In other embodiments, a library of variable content is collected and randomly utilized. The system collects feedback information on how often the content is “successful” and raises or lowers the content's ranking within the library based upon these measures of success. Success may be defined as eliciting an answer when the variable content is a question or receiving acknowledgment of understanding when the variable content is informational. Salutations and closing may be ranked on success when the target continues conversing. Once a sufficient number of variants have been utilized a number of times the system may selects which variable content used weighted by the ranking of success within the variant library. In some embodiments this may include selecting only the top 3-5 variants for the given template field. In other embodiments, any variant may be selected, but the probability of each variant being selected may be modified by its ranking. Such a selection process ensures the ‘best’ variants are used the most, but still enables greater variety in messaging and, more importantly, continued testing of variants to ensure that the rankings continue to change and become more accurate over time.

Additionally, the variable content may be modified by a “personality” of the particular account. A given conversation takes place between the AI system and a user, however each AI system may engage in hundreds or even thousands of simultaneous conversations. Each conversation, or group of conversations, is conducted between the user and a ‘personality’ however. In some cases, these ‘personalities’ may behave like an actual human actor, such as an automated assistant as will be discussed in more detail below. Likewise, a personality that engages with a user over multiple message exchanges will typically have a name and a unique email address (or other means for contacting it). Each of these embodiments of the AI system may have ‘quirks’ to their behavior, again in an attempt to mimic human interaction. This is different from traditional AI systems like Siri used by Apple. Siri, and similar AI tools, behave identically for every user. One version of Siri used on one device is no more or less playful, educated, or friendly than any other version. While this allows for consistent interactions, it reinforces the robotic nature of this AI system. The present AI conversation systems allows for setting (either by the system in an automated fashion or by a user selection) of personality traits. These traits may be placed on a linear scale and may influence variable content selection. A personality endower 562 may enable the setting of these traits, and the reflection of them in the variable language chosen.

For example, in the library of possible content for a given variable, a series of fields may be appended as metadata to each content. For example, if the variable is for a salutation, the potential options may be “Dear [name_last]”, “Hi [name_first]”, “Hey [nickname]” and simply “[name_last]” in this example. Each of these may be appended with the following metadata: [1,10,4], [7,7,8], [10,5, 7], and [3,5,10], respectively. These fields may correspond to a one to ten scale for playfulness, professionalism and confidence, respectively. For a given personality that is ranked a three for playfulness, an eight for professionalism, and a seven for confidence, the salutation best suited would be “Hi [name_first]”. This can be determined by subtracting the personality traits of the AI agent against the variable phrase trait score and adding together the absolute values of these scores together. The variable with the smallest number is then selected. In this example, while the salutation is considered more playful than the AI personality, the salutation is very close in terms of professionalism and degree of confidence it projects. Using the above described technique, the difference in scores is only five (one for difference in professionalism and four for playfulness). Of course, alternate techniques may likewise be employed for determining closeness between a personality and a given variable, such as clustering techniques, least mean squares, or alternate distance techniques.

Personality selection of content may be performed alone for selection of variable content to be incorporated into a given field or may be combined with the ranked based selection whereby the most successful content is preferentially employed. In some situations, the personality-based content selection may be afforded a weight and the rank-based system another rank, and a random variable a third weight. In some embodiments, these weights may be 50%, 30% and 20%. Thus, generally the content that matches the personality of the agent is used, but the ‘best’ match for the personality may sometimes be skipped for another selection if other content is routinely found to be more successful. Returning to the prior example, while “Hi [name_first]” was determined to be most apt for the given personality, the usage of “[name_last]” is a close second contender (being only six away from the personality). If “[name_last]” has historically been twice as successful in getting a response from the target, then even though this is not the first choice for the personality, it may be the preferred variable to use in most situations. However, this may be further altered based upon a random score given to each variable for each selection incident. Again, this random element adds variability to the messaging, and allows continued testing of the variable terms.

Lastly, a message disambiguator 563 may be employed when the system determines that a response form the target is not specific enough to be accurately interpreted. For example, if the AI system asks in a message “Are you still interested in a call, or would you like to test the product first?” and the target responds with a “yes” it may not be clear what “yes” means. If the target desiring to have a call, or test the product? The AI system has no problems determining the meaning of the target's response, but in context of the earlier message it is unclear what it actually means. Most of the time this is avoided by having original messages that are not compound questions and are answered in simple terms; however even the best crafted message can sometimes elicit an ambiguous response. It should be noted that an ambiguous message is different from, and responded to differently, from a message whose classification cannot be determined at a satisfactory level. Even the best AI classification models may occasionally be unable to classify a message to a needed confidence threshold. In such situations the AI system may forward the message to a user for help. In contrast, when a message is able to be classified accurately, but is still ambiguous, the message disambiguater 563 may instead generate a response to the user that explicitly seeks clarification (as opposed to seeking human intervention).

Returning to the prior example, the message disambiguater 563 may return to the user a question of “Just to be clear, you would like to set up a phone call, right?” This forces the target to delineate the actual meaning of the response.

FIG. 5C provides an example diagram of the message delivery handler 570. This system component receives output form the dynamic messager 560 and performs its own processing to arrive at the final outgoing message. The message delivery handler 570 may include a hierarchical conversation library 571 for storing all the conversation components for building a coherent message. The hierarchical conversation library 571 may be a large curated library, organized and utilizing multiple inheritance along a number of axes: organizational levels, access-levels (rep->group->customer->public). The hierarchical conversation library 571 leverages sophisticated library management mechanisms, involving a rating system based on achievement of specific conversation objectives, gamification via contribution rewards, and easy searching of conversation libraries based on a clear taxonomy of conversations and conversation trees.

In addition to merely responding to a message with a response, the message delivery handler 570 may also include a set of actions that may be undertaken linked to specific triggers, these actions and associations to triggering events may be stored in an action response library 572. For example, a trigger may include “Please send me the brochure.” This trigger may be linked to the action of attaching a brochure document to the response message. The system may choose attachment materials from a defined library (SalesForce repository, etc.), driven by insights gained from parsing and classifying the previous response, or other knowledge obtained about the target, client, and conversation. Other actions could include initiating a purchase (order a pizza for delivery for example) or pre-starting an ancillary process with data known about the target (kick of an application for a car loan, with name, etc. already pre-filled in for example).

In addition to receiving specific variable content for inclusion by the dynamic messager 560, the message delivery handler 570 may have a weighted phrase package selector 573 that incorporates phrase packages into a generated message based upon their common usage together, or by some other metric.

Lastly, the message delivery handler 570 may operate to select which language to communicate using. In prior disclosures, it was noted that embodiments of the AI classification system systems may be enabled to perform multiple language analysis. Rather than perform classifications using full training sets for each language, as is the traditional mechanism, the systems leverage dictionaries for all supported languages, and translations to reduce the needed level of training sets. In such systems, a primary language is selected, and a full training set is used to build a model for the classification using this language. Smaller training sets for the additional languages may be added into the machine learned model. These smaller sets may be less than half the size of a full training set, or even an order of magnitude smaller. When a response is received, it may be translated into all the supported languages, and this concatenation of the response may be processed for classification. The flip side of this analysis is the ability to alter the language in which new messages are generated. For example, if the system detects that a response is in French, the classification of the response may be performed in the above-mentioned manner, and similarly any additional messaging with this contact may be performed in French.

Determination of which language to use is easiest if the entire exchange is performed in a particular language. The system may default to this language for all future conversation. Likewise, an explicit request to converse in a particular language may be used to determine which language a conversation takes place in. However, when a message is not requesting a preferred language, and has multiple language elements, the system may query the user on a preferred language and conduct all future messaging using the preferred language.

### II. Methods

Now that the systems for dynamic messaging and natural language processing techniques have been broadly described, attention will be turned to processes employed to perform AI driven conversations, as well as example processes for enhanced natural language processing.

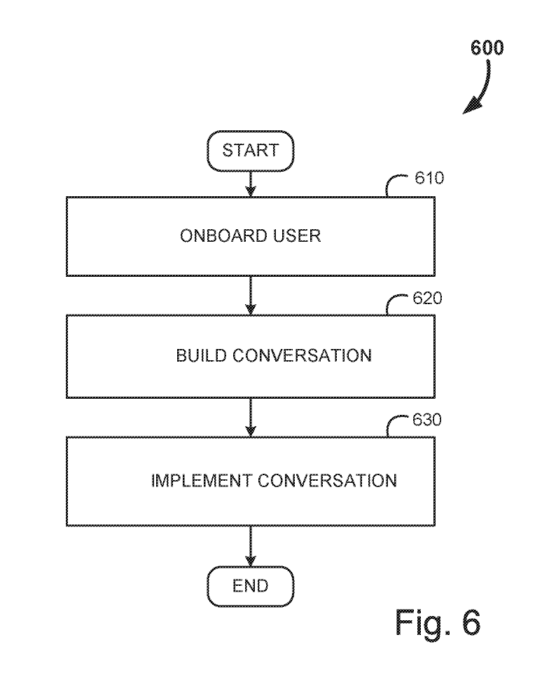

In FIG. 6 an example flow diagram for a dynamic message conversation is provided, shown generally at 600. The process can be broadly broken down into three portions: the on-boarding of a user (at 610), conversation generation (at 620) and conversation implementation (at 630). The following figures and associated disclosure will delve deeper into the specifics of these given process steps.

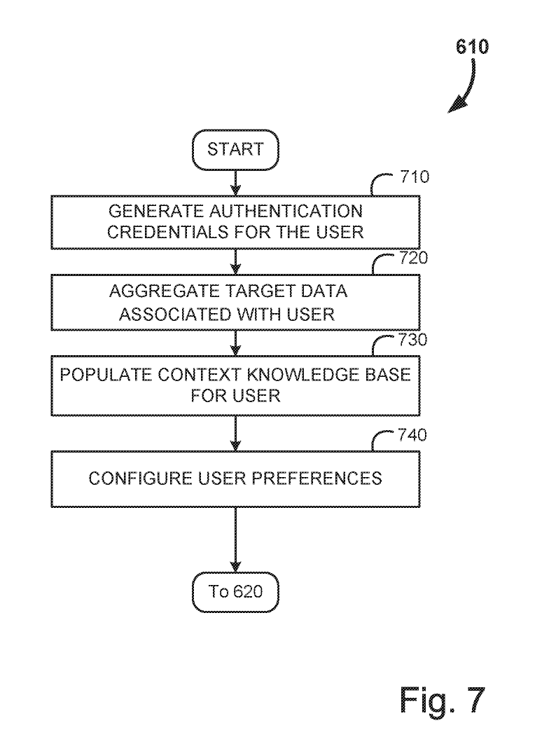

FIG. 7, for example, provides a more detailed look into the on-boarding process, shown generally at 610. Initially a user is provided (or generates) a set of authentication credentials (at 710). This enables subsequent authentication of the user by any known methods of authentication. This may include username and password combinations, biometric identification, device credentials, etc.

Next, the target data associated with the user is imported, or otherwise aggregated, to provide the system with a target database for message generation (at 720). Likewise, context knowledge data may be populated as it pertains to the user (at 730). Often there are general knowledge data sets that can be automatically associated with a new user; however, it is sometimes desirable to have knowledge sets that are unique to the user's conversation that wouldn't be commonly applied. These more specialized knowledge sets may be imported or added by the user directly.

Lastly, the user is able to configure their preferences and settings (at 740). This may be as simple as selecting dashboard layouts, to configuring confidence thresholds required before alerting the user for manual intervention.

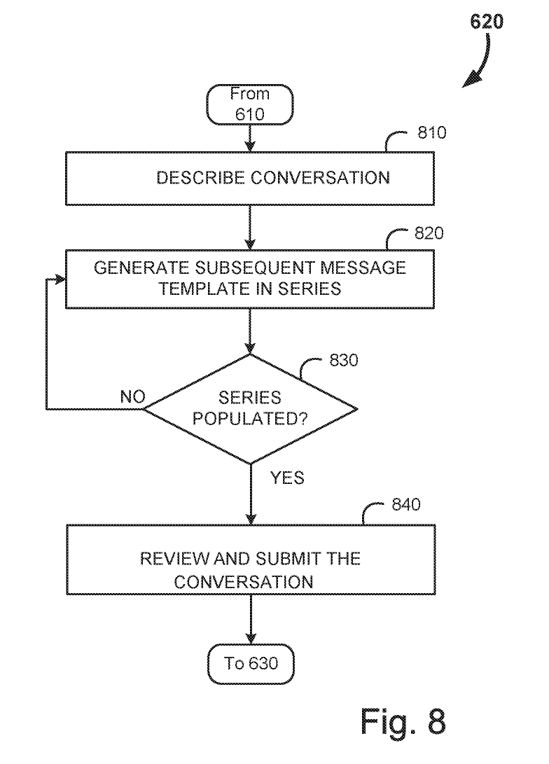

Moving on, FIG. 8 is the example flow diagram for the process of building a conversation, shown generally at 620. The user initiates the new conversation by first describing it (at 810). Conversation description includes providing a conversation name, description, industry selection, and service type. The industry selection and service type may be utilized to ensure the proper knowledge sets are relied upon for the analysis of responses.

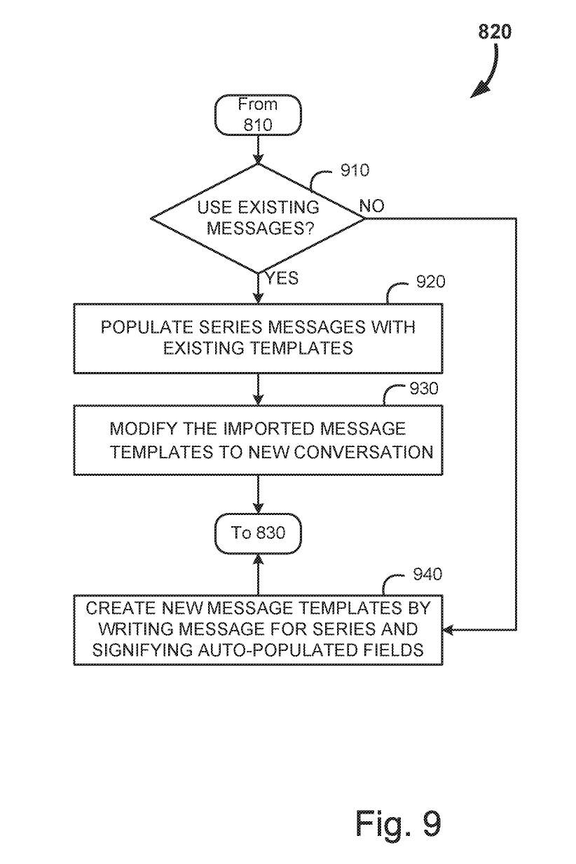

After the conversation is described, the message templates in the conversation are generated (at 820). If the series is populated (at 830), then the conversation is reviewed and submitted (at 840). Otherwise, the next message in the template is generated (at 820). FIG. 9 provides greater details of an example of this sub-process for generating message templates. Initially the user is queried if an existing conversation can be leveraged for templates, or whether a new template is desired (at 910).

If an existing conversation is used, the new message templates are generated by populating the templates with existing templates (at 920). The user is then afforded the opportunity to modify the message templates to better reflect the new conversation (at 930). Since the objectives of many conversations may be similar, the user will tend to generate a library of conversations and conversation fragments that may be reused, with or without modification, in some situations. Reusing conversations has time saving advantages, when it is possible.

However, if there is no suitable conversation to be leveraged, the user may opt to write the message templates from scratch using the Conversation Editor (at 940). When a message template is generated, the bulk of the message is written by the user, and variables are imported for regions of the message that will vary based upon the target data. Successful messages are designed to elicit responses that are readily classified. Higher classification accuracy enables the system to operate longer without user interference, which increases conversation efficiency and user workload.

Messaging conversations can be broken down into individual objectives for each target. Designing conversation objectives allows for a smoother transition between messaging series. Table 2 provides an example set of messaging objectives for a sales conversation.

TABLE 2
Template Objectives

| Series | Objective |
|---|---|
| 1 | Verify Email Address |
| 2 | Obtain Phone Number |
| 2 | Introduce Sales Representative |
| 3 | Verify Rep Follow-Up |

Likewise, conversations can have other arbitrary set of objectives as dictated by client preference, business function, business vertical, channel of communication and language. Objective definition can track the state of every target. Inserting personalized objectives allows immediate question answering at any point in the lifecycle of a target. The state of the conversation objectives can be tracked individually as shown below in reference to Table 3.

TABLE 3
Objective tracking

| Target | Conversation | | | | |
|---|---|---|---|---|---|
| ID | ID | Objective | Type | Pending | Complete |
| 100 | 1 | Verify Email | Q | 1 | 1 |
| | | Address | | | |
| 100 | 1 | Obtain Phone | Q | 0 | 1 |
| | | Number | | | |
| 100 | 1 | Give Location | I | 1 | 0 |
| | | Details | | | |
| 100 | 1 | Verify Rep | Q | 0 | 0 |
| | | Follow-Up | | | |

Table 3 displays the state of an individual target assigned to conversation 1, as an example. With this design, the state of individual objectives depends on messages sent and responses received. Objectives can be used with an informational template to make a series transition seamless. Tracking a target's objective completion allows for improved definition of target's state, and alternative approaches to conversation message building. Conversation objectives are not immediately required for dynamic message building implementation but become beneficial soon after the start of a conversation to assist in determining when to move forward in a series.

Dynamic message building design depends on ‘message_building’ rules in order to compose an outbound document. A Rules child class is built to gather applicable phrase components for an outbound message. Applicable phrases depend on target variables and target state.

To recap, to build a message, possible phrases are gathered for each template component in a template iteration. In some embodiment, a single phrase can be chosen randomly from possible phrases for each template component. Alternatively, as noted before, phrases are gathered and ranked by “relevance”. Each phrase can be thought of as a rule with conditions that determine whether or not the rule can apply and an action describing the phrase's content.

Relevance is calculated based on the number of passing conditions that correlate with a target's state. A single phrase is selected from a pool of most relevant phrases for each message component. Chosen phrases are then imploded to obtain an outbound message. Logic can be universal or data specific as desired for individual message components.

Variable replacement can occur on a per phrase basis, or after a message is composed. Post message-building validation can be integrated into a message-building class. All rules interaction will be maintained with a messaging rules model and user interface.

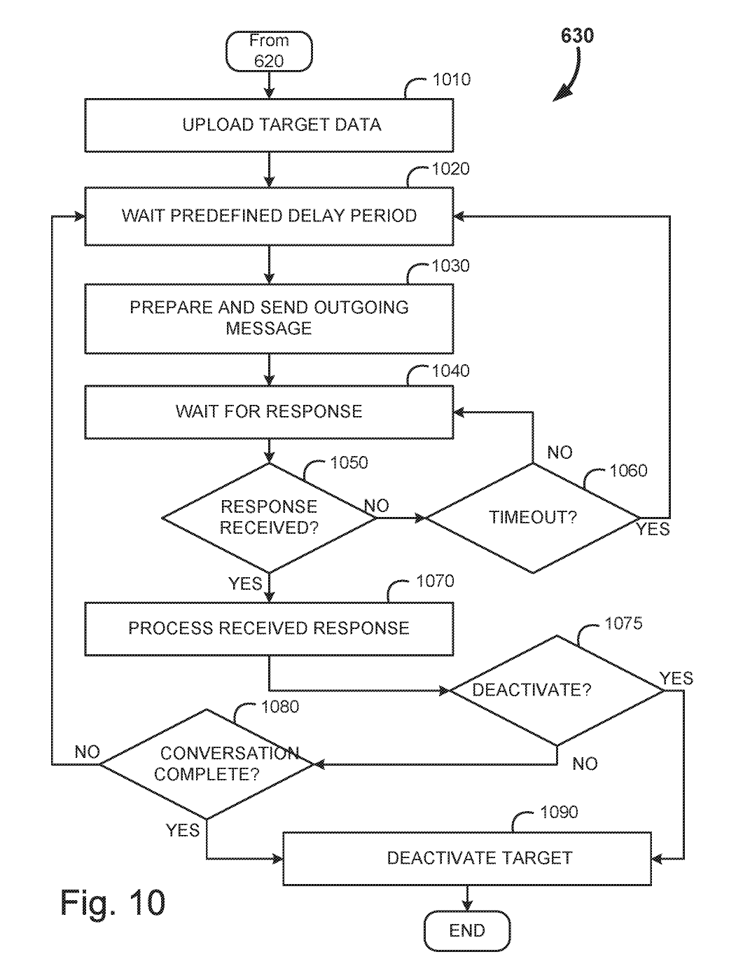

Once the conversation has been built out it is ready for implementation. FIG. 10 is an example flow diagram for the process of implementing the conversation, shown generally at 630. Here the lead (or target) data is uploaded (at 1010). Target data may include any number of data types, but commonly includes names, contact information, date of contact, item the target was interested in (in the context of a sales conversation), etc. Other data can include open comments that targets supplied to the target provider, any items the target may have to trade in, and the date the target came into the target provider's system. Often target data is specific to the industry, and individual users may have unique data that may be employed.

An appropriate delay period is allowed to elapse (at 1020) before the message is prepared and sent out (at 1030). The waiting period is important so that the target does not feel overly pressured, nor the user appears overly eager. Additionally, this delay more accurately mimics a human correspondence (rather than an instantaneous automated message). Additionally, as the system progresses and learns, the delay period may be optimized by a cadence optimizer to be ideally suited for the given message, objective, industry involved, and actor receiving the message.

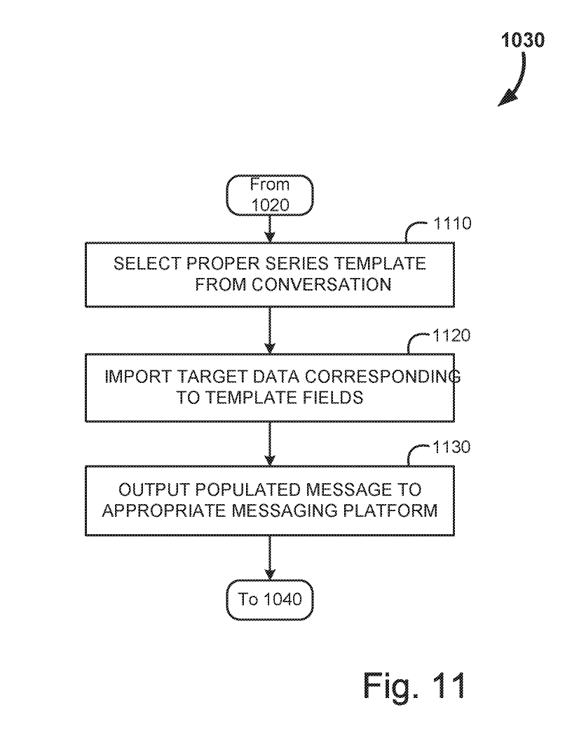

FIG. 11 provides a more detailed example of the message preparation and output. In this example flow diagram, the message within the series is selected based upon which objectives are outstanding (at 1110). Typically, the messages will be presented in a set order; however, if the objective for a particular target has already been met for a given series, then another message may be more appropriate. Likewise, if the recipient didn't respond as expected, or not at all, it may be desirous to have alternate message templates to address the target most effectively.

After the message template is selected from the series, the target data is parsed through, and matches for the variable fields in the message templates are populated (at 1120). Variable filed population, as touched upon earlier, is a complex process that may employ personality matching, and weighting of phrases or other inputs by success rankings. These methods will also be described in greater detail when discussed in relation to variable field population in the context of response generation. Such processes may be equally applicable to this initial population of variable fields.

The populated message is output to the communication channel appropriate messaging platform (at 1130), which as previously discussed typically includes an email service, but may also include SMS services, instant messages, social networks, audio networks using telephony or speakers and microphone, or video communication devices or networks or the like. In some embodiments, the contact receiving the messages may be asked if he has a preferred channel of communication. If so, the channel selected may be utilized for all future communication with the contact. In other embodiments, communication may occur across multiple different communication channels based upon historical efficacy and/or user preference. For example, in some particular situations a contact may indicate a preference for email communication. However, historically, in this example, it has been found that objectives are met more frequently when telephone messages are utilized. In this example, the system may be configured to initially use email messaging with the contact, and only if the contact becomes unresponsive is a phone call utilized to spur the conversation forward. In another embodiment, the system may randomize the channel employed with a given contact, and over time adapt to utilize the channel that is found to be most effective for the given contact.

Returning to FIG. 10, after the message has been output, the process waits for a response (at 1040). If a response is not received (at 1050) the process determines if the wait has been timed out (at 1060). Allowing a target to languish too long may result in missed opportunities; however, pestering the target too frequently may have an adverse impact on the relationship. As such, this timeout period may be user defined and will typically depend on the communication channel. Often the timeout period varies substantially, for example for email communication the timeout period could vary from a few days to a week or more. For real-time chat communication channel implementations, the timeout period could be measured in seconds, and for voice or video communication channel implementations, the timeout could be measured in fractions of a second to seconds. If there has not been a timeout event, then the system continues to wait for a response (at 1050). However, once sufficient time has passed without a response, it may be desirous to return to the delay period (at 1020) and send a follow-up message (at 1030). Often there will be available reminder templates designed for just such a circumstance.

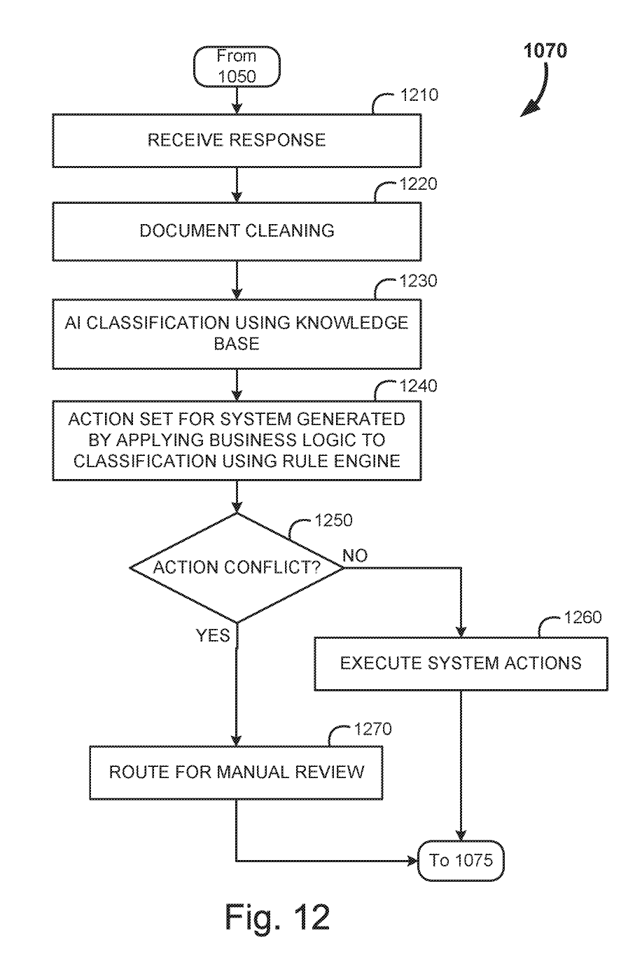

However, if a response is received, the process may continue with the response being processed (at 1070). This processing of the response is described in further detail in relation to FIG. 12. In this sub-process, the response is initially received (at 1210) and the document may be cleaned (at 1220).

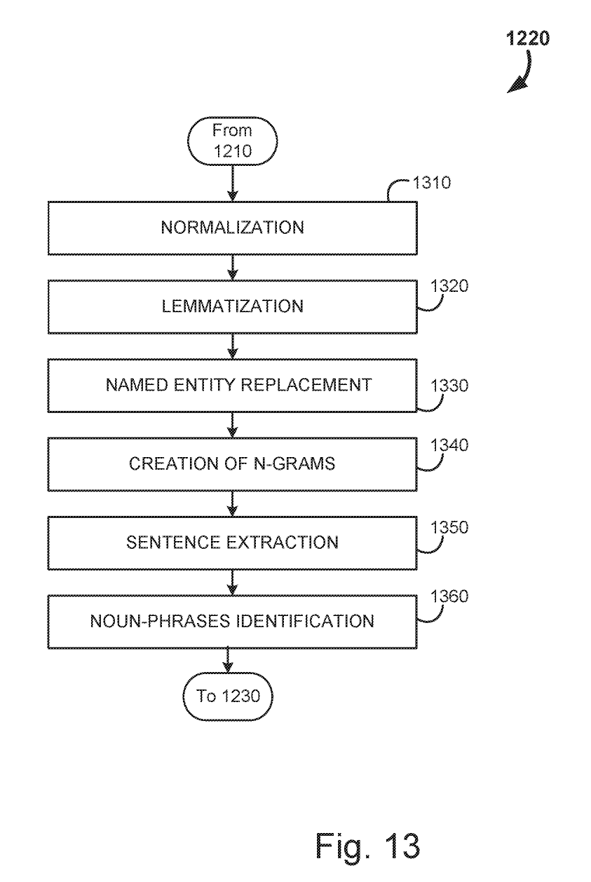

Document cleaning is described in greater detail in relation with FIG. 13. Upon document receipt, adapters may be utilized to extract information from the document for shepherding through the cleaning and classification pipelines. For example, for an email, adapters may exist for the subject and body of the response, often a number of elements need to be removed, including the original message, HTML encoding for HTML style responses, enforce UTF-8 encoding so as to get diacritics and other notation from other languages, and signatures so as to not confuse the AI. Only after all this removal process does the normalization process occur (at 1310) where characters and tokens are removed in order to reduce the complexity of the document without changing the intended classification.

After the normalization, documents are further processed through lemmatization (at 1320), name entity replacement (at 1330), the creation of n-grams (at 1340) sentence extraction (at 1350), noun-phrase identification (at 1360) and extraction of out-of-office features and/or other named entity recognition (at 1370). Each of these steps may be considered a feature extraction of the document. Historically, extractions have been combined in various ways, which results in an exponential increase in combinations as more features are desired. In response, the present method performs each feature extraction in discrete steps (on an atomic level) and the extractions can be “chained” as desired to extract a specific feature set.

Returning to FIG. 12, after document cleaning, the document is then provided to the AI platform for classification using the knowledge sets (at 1230). For the purpose of this disclosure, a “knowledge set” is a corpus of domain specific information that may be leveraged by the machine learned classification model. The knowledge sets may include a plurality of concepts and relationships between these concepts. It may also include basic concept-action pairings. The AI Platform will apply large knowledge sets to classify ‘Continue Messaging’, ‘Do Not Email’ and ‘Send Alert’ insights. Additionally, various domain specific ‘micro-insights’ can use smaller concise knowledge sets to search for distinct elements in responses.

For example, a ‘Requested Location’ insight can be trained to determine if a target has requested location details. The additional insights should be polled for each incoming message. Knowledge can be universal or target/conversation/question specific, if needed. Insight and knowledge set interaction will be maintained using the AI API within the AI Dashboard user interfaces.

A user interface exists to interact with message building rules. The rule creation interface allows for easy message building management and provide previews of all possible message compositions. The AI dashboard toolset can be expanded upon to build and apply new insights and knowledge sets. This AI dashboard may exist within administrative dashboards or as independent developer interfaces.

The system initially applies natural language processing through one or more AI machine learning models to process the message for the concepts contained within the message. As previously mentioned, there are a number of known algorithms that may be employed to categorize a given document, including Hard rule, Naïve Bayes, Sentiment, neural nets including convolutional neural networks and recurrent neural networks and variations, k-nearest neighbor, other vector-based algorithms, etc. to name a few. In some embodiments, the classification model may be automatically developed and updated as previously touched upon, and as described in considerable detail below as well. Classification models may leverage deep learning and active learning techniques as well, as will also be discussed in greater detail below.

After the classification has been generated, the system renders intents from the message. Intents, in this context, are categories used to answer some underlying question related to the document. The classifications may map to a given intent based upon the context of the conversation message. A confidence score, and accuracy score, are then generated for the intent. Intents are used by the model to generate actions.

Objectives of the conversation, as they are updated, may be used to redefine the actions collected and scheduled. For example, ‘skip-to-follow-up’ action may be replaced with an ‘informational message’ introducing the sales rep before proceeding to ‘series 3’ objectives. Additionally, ‘Do Not Email’ or ‘Stop Messaging’ classifications should deactivate a target and remove scheduling at any time during a target's life-cycle. Intents and actions may also be annotated with “facts”. For example, if the determined action is to “check back later” this action may be annotated with a date ‘fact’ that indicates when the action is to be implemented.

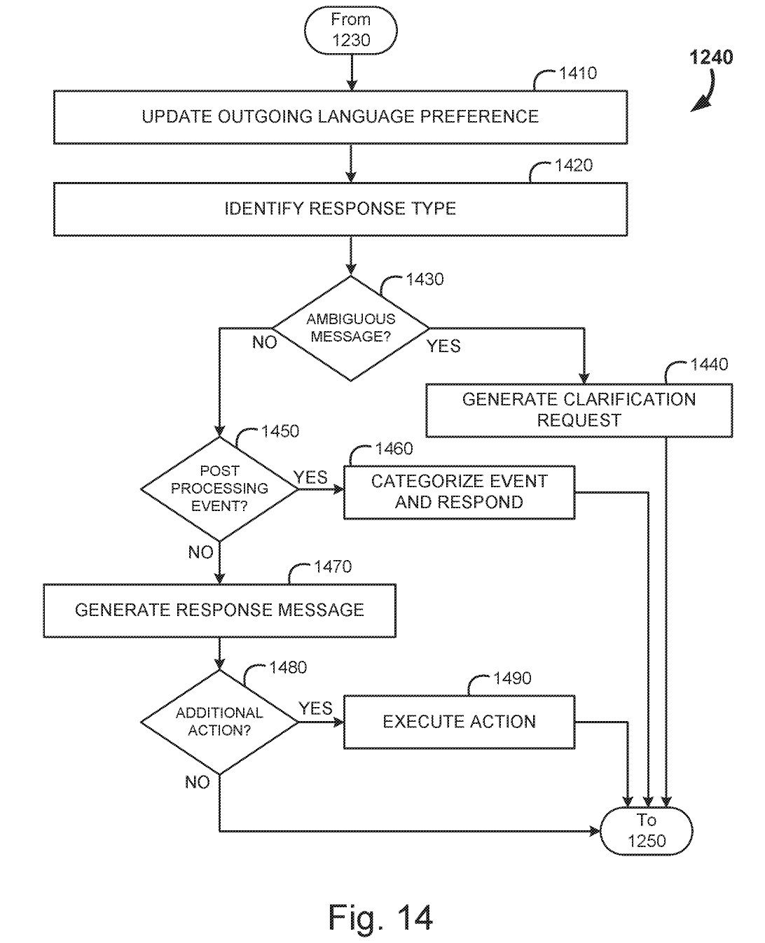

Returning to FIG. 12, the actions received from the inference engine may be set (at 1240). FIG. 14 provides a more detailed flow chart disclosing an example process for the setting of the action, shown at 1240. In this example process, the language utilized in the conversation may be initially checked and updated accordingly (at 1410). As noted previously, language selection may be explicitly requested by the target, or may be inferred from the language used thus far in the conversation. If multiple languages have been used in any appreciable level, the system may likewise request a clarification of preference from the target. Lastly, this process may include responding appropriately if a message language is not supported.

After language preference is determined, the response type is identified (at 1420) based upon the message it is responding to (question, versus informational, vs. introductory, etc.) as well as classifications. Next a determination is made if the response was ambiguous (at 1430). As noted previously, an ambiguous message is one for which a classification can be rendered at a high level of confidence, but which meaning is still unclear due to lack of contextual cues. Such ambiguous messages may be responded to by generating and sending a clarification request (at 1440).

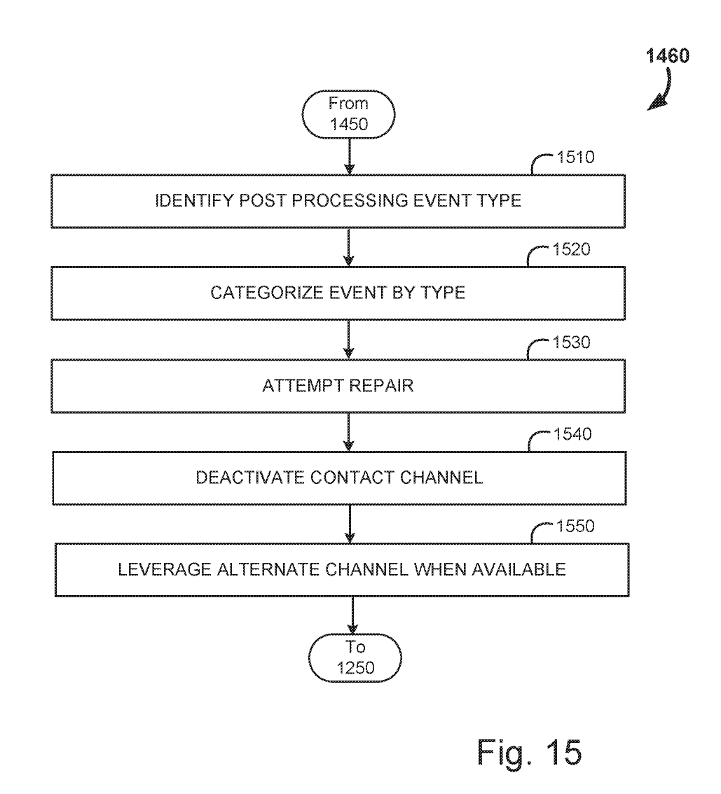

However, if the message is not ambiguous, a separate determination may be performed to determine if a post processing event is needed (at 1450). Post processing events include bounced emails, disconnected phone numbers, or other events that impede with the conversation. If such an event exists, the system may categorize and respond to the event accordingly (at 1460). FIG. 15 provides more detailed flow diagram for this response to post processing events and begins with identification of the post processing event type (at 1510). This is important, because a failure to deliver an email may be treated very differently than an automated vacation notice, etc. The event is next categorized by its type (at 1520) and a repair is attempted (at 1530). For example, if an email message bounces the system may initially confirm the email address against prior successful emails, query public databases for updates to email addresses (as commonly occurs after a name change) and seek clarification using alternate communication channels (even if said channels are not preferred). The defective channel may then be deactivated (at 1540), and alternate channels may be leveraged if identified during the repair attempt (at 1550).

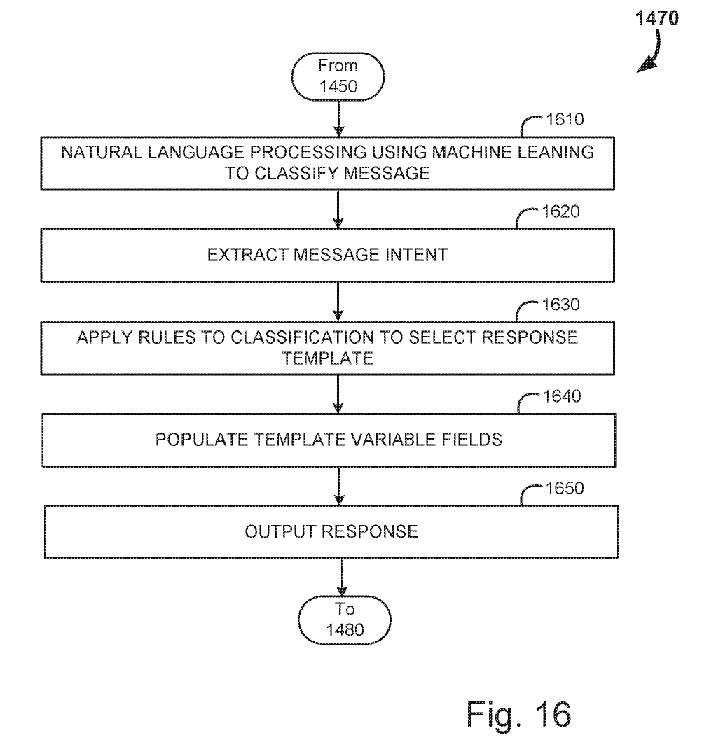

Returning to FIG. 14, if no post processing event is present the response message may be generated in a manner disclosed in greater detail in relation to FIG. 16. As noted before the natural language processing, using machine learning, has been used to classify the message (at 1610). The intent of the message is thus extracted (at 1620) and rules are applied to the classification and intent to select which response template to utilize (at 1630). The rules employed include identifying the type of message was being responded to (informative versus question for example) and rules linking classifications and intents to response types. Responses to informational messages may be classified differently than responses to questions. Classification depends on the type of responses received by each outgoing message. ‘Do Not Email’ or ‘Stop Messaging’ classifications should deactivate a target and remove scheduling at any time during a lead's lifecycle. Target objectives are also updated as a result of the classifications. If the AI makes a ‘continue messaging’ classification and incomplete objectives remain, the next messaging series will be scheduled. However, with the introduction of informational messages, it will be desirable to send multiple messages for a single series. For example, if a target is found to request location details in a series 2 response, it may be desirable to schedule an immediate informational message and a delayed follow-up verification.

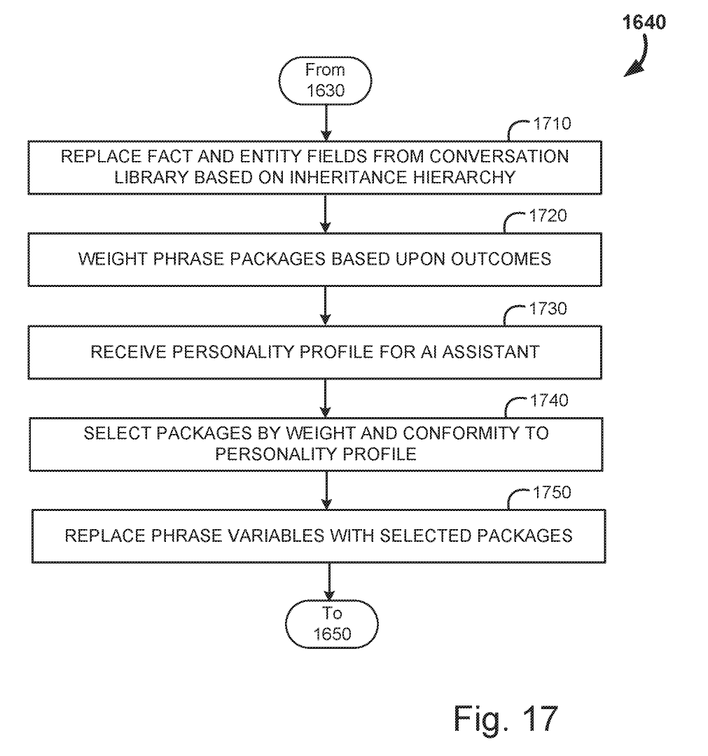

Once the proper template is identified the variable fields within the template are populated (at 1640) which is described in greater detail in FIG. 17. Population of the variable fields includes replacement of facts and entity fields from the conversation library based upon an inheritance hierarchy (at 1710). As noted previously, the conversation library is curated and includes specific rules for inheritance along organization levels and degree of access. This results in the insertion of customer/industry specific values at specific place in the outgoing messages, as well as employing different lexica or jargon for different industries or clients. Wording and structure may also be influenced by defined conversation objectives and/or specific data or properties of the specific target.

After basic entity and fact replacement, specific phrases may be selected (at 1720) based upon weighted outcomes (success ranks). The system calculates phrase relevance scores to determine the most relevant phrases given a lead state, sending template, and message component. Some (not all) of the attributes used to describe lead state are: the client, the conversation, the objective (primary versus secondary objective), series in the conversation and attempt number in the series, insights, target language and target variables. For each message component, the builder filters (potentially thousands of) phrases to obtain a set of maximum-relevance candidates. In some embodiments, within this set of maximum-relevance candidates, a single phrase is randomly selected to satisfy a message component. As feedback is collected, phrase selection is impacted by phrase performance over time, as discussed previously. In some embodiments, every phrase selected for an outgoing message is logged. Sent phrases are aggregated into daily windows by Client, Conversation, Series, and Attempt. When a response is received, phrases in the last outgoing message are tagged as ‘engaged’. When a positive response triggers another outgoing message, the previous sent phrases are tagged as ‘continue’. The following metrics are aggregated into daily windows: total sent, total engaged, total continue, engage ratio, and continue ratio.

To impact message-building, phrase performance must be quantified and calculated for each phrase. This may be performed using the following equation:

$$\begin{matrix}Phrase performance & \\ performance = \frac{( {percent}_{engaged} + {percent}_{continue} )}{2} & Equation 1\end{matrix}$$

Engagement and continuation percentages are gathered based on messages sent within the last 90 days, or some other predefined history period. Performance calculations enable performance-driven phrase selection. Relative scores within maximum-relevance phrases can be used to calculate a selection distribution in place of random distribution.

Phrase performance can fluctuate significantly when sending volume is low. To minimize error at low sending volumes, a

$$\frac{ln ( x )}{x}$$

padding window is applied to augment all phrase-performance scores. The padding is effectively zero when total_sent is larger than 1,500 sent messages. This padded performance is performed using the following equation:

$$\begin{matrix}Padded performance & \\ {performance}_{pad} = 100 \times \frac{ln ( {total}_{sent} + {LN}_{OFFSET} )}{{total}_{sent} + {ZERO}_{OFFSET}} & Equation 2\end{matrix}$$

Performance scores are augmented with the performance pad prior to calculating distribution weights using the following equation:

performance □′=performance+performance_{pad} Equation 3: Augmented phrase performance

As noted, phrase performance may be calculated based on metrics gathered in the last 90 days. That window can change to alter selection behavior. Weighting of metrics may also be based on time. For example, metrics gathered in the last 30 days may be assigned a different weight than metrics gathered in the last 30-60 days. Weighting metrics based on time may affect selection behaviors as well. Phrases can be shared across client, conversation series, attempt, etc. It should be noted that alternate mechanisms for calculating phrase performance are also possible, such as King of the Hill or Reinforcement Learning, deep learning, etc.

Due to the fact that message attempt is correlated with engagement; metrics are gathered per attempt to avoid introducing engagement bias. Additionally, variable values can impact phrase performance; thus, calculating metrics per client is done to avoid introducing variable value bias.

Adding performance calculations to message building increases the amount of time to build a single message. System improvements are required to offset this additional time requirement. These may include caching performance data to minimize redundant database queries, aggregating performance data into windows larger than one day, and aggregating performance values to minimize calculations made at runtime.

In addition to performance-based selection, as discussed above, phrase selection may be influenced by the “personality” of the system for the given conversation. As noted, the users can adjust the strength of various personality traits. This personality profile is received by the system (at 1730). These may include, but are not limited to the following: folksy/educated, down to earth/idealistic, professional/playful, stiff/casual, serious/silly, confident/cautious, prompt/tardy, persistent/flexible, polite/blunt, etc. The user may employ a set of adjustable slider controls to set the personality profile of a given AI identity. Message phrase packages are constructed to be tone, cadence, and timbre consistent throughout, and are tagged with descriptions of these traits (professional, firm, casual, friendly, etc.), using standard methods from cognitive psychology. Additionally, in some embodiments discussed previously, each phrase may include a matrix of metadata that quantifies the degree a particular phrase applies to each of the traits. The system will then map these traits to the correct set of descriptions of the phrase packages and enable the correct packages. This will allow customers or consultants to more easily get exactly the right Assistant personality (or conversation personality) for their company, particular target, and conversation. This may then be compared to the identity personality profile, and the phrases which are most similar to the personality may be preferentially chosen, in combination with the phrase performance metrics (at 1740). As noted before, a random element may additionally be incorporated in some circumstances to add phrase selection variability and/or continued phrase performance measurement accuracy. After phrase selection, the phrases replace the variables in the template (at 1750). Returning to FIG. 16, the completed templates are then output as a response (at 1650).

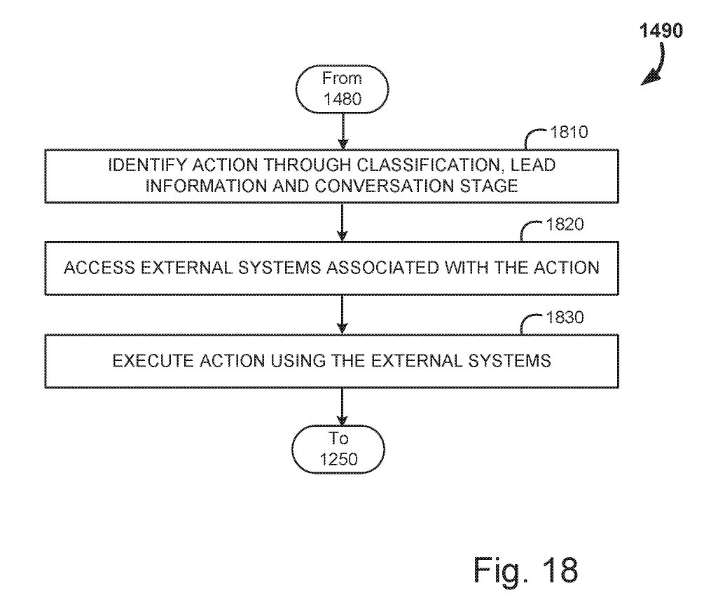

Returning to FIG. 14, after response generation, an inquiry is made if any additional actions are required (at 1480). If so, then the required action is executed (at 1490). This additional action process is shown in greater detail in relation to FIG. 18. Initially the action to be taken needs to be identified by a triggering phrase, conversation stage, classification, or target information (at 1810). Subsequently, at least one external system associated with the action is accessed (at 1820) and employed to execute the action (at 1830). As noted previously, actions may be as simple as the attachment of some data or document to a communication or may include actions such as ordering/purchasing via online portals, updating calendars, sending meeting invitations, and updating Salesforce records, initialize a secondary process by auto-populating with known information, and the like.

Returning to FIG. 12, after the actions are generated, a determination is made whether there is an action conflict (at 1250). Manual review may be needed when such a conflict exists (at 1270). Otherwise, the actions may be executed by the system (at 1260).

Returning to FIG. 10, after the response has been processed, a determination is made whether to deactivate the target (at 1075). Such a deactivation may be determined as needed when the target requests it. If so, then the target is deactivated (at 1090). If not, the process continues by determining if the conversation for the given target is complete (at 1080). The conversation may be completed when all objectives for the target have been met, or when there are no longer messages in the series that are applicable to the given target. Once the conversation is completed, the target may likewise be deactivated (at 1090).

However, if the conversation is not yet complete, the process may return to the delay period (at 1020) before preparing and sending out the next message in the series (at 1030). The process iterates in this manner until the target requests deactivation, or until all objectives are met. This concludes the main process for a comprehensive messaging conversation.

Now that the messaging methods have been discussed in detail attention will be turned to the interface that may be employed to set a personality profile for an AI identity. As noted before, this may be a specific AI assistant, or may be a particular conversational bot. In advanced systems, it is possible, through the generation of these AI identities to have a scalable workforce that may be expanded in virtual perpetuity. This results in an ever-increasing possibility that an AI may interface with another AI identity. In these circumstances, it is advantageous to have a protocol for communication, across conventional communication networks, that allows for hyper efficient communications. For example, rather than generating a message based upon objectives, then classifying the message to determine intent, and building a response based upon objectives of the responding AI, the systems may communicate in terms of stated objectives and conceptual intent terms. This eliminates the need for computationally expensive classifications since the intent of the message is already provided to the message builder.

In such situations where two AI systems (or even two identities on the same AI system) the communication may include metadata that is not perceived by a human but indicates to the recipient that they are conversing with an AI. For a phone conversation that could include an ultra-sonic tone that a human cannot perceive (30-50 kHz in frequency for example). For an email message, this indicator could include email header metadata, or even incredibly minute background colorations that are not perceivable by a human but can be recognized by a computer system. Once detected that a given AI is communicating with another AI the systems may proceed to converse using the AI optimized protocol of intents and objectives listed with appropriate tags.

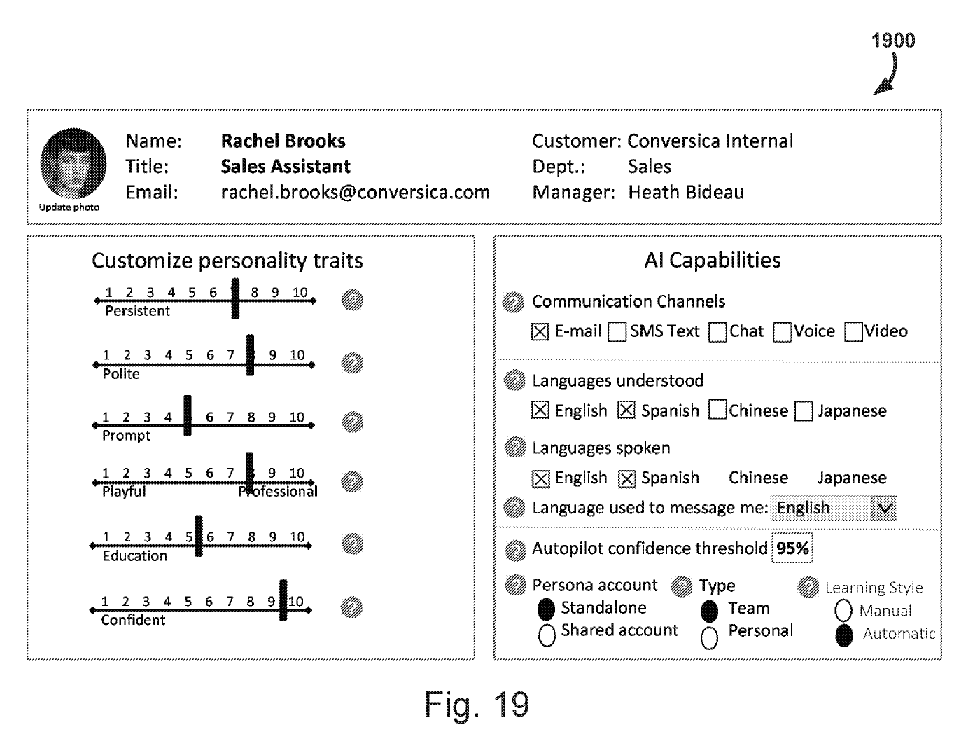

FIG. 19 is an example illustration of such a configurable AI personality dashboard within a conversation system, shown generally at 1900. In this example interface, an avatar for the conversation personality and biographical data can be inserted. This may include giving the personality a name, manager/line of business, contact information and role within the organization. A series of slider bars may correspond to specific personality traits, which may be expressed in the conversation outputs. For example, traits like persistence, politeness, promptness, playfulness, perceived education level, and confidence may be selected. The responses generated for a given personality profile, while maintaining the same content, may vary significantly based upon these selections, as discussed previously. For example, a polite, professional, educated and confident personality may generate a response that states “Dear Ms. Smith, I appreciate your time, and suggest we schedule a call for tomorrow at 10 am. Please confirm. Cordially, Mrs. Brooks.” In contrast, a less educated, more playful and less confident personality could generate the following: “Hi Mary, great talking. Let's have a call maybe tomorrow? 10ish if that works for you. Thanks!—R.” Note the content of each message is identical: a salutation, followed by an appreciative platitude, and a suggestion for a call at a specific time. However, the selection of word phrases varies significantly based upon personality selections.

In this interface, the user is also capable of selecting other capabilities for the AI personality, including communication channels, languages understood and spoken, and what level of confidence the classification threshold needs to be at before routing to the training desk (human intervention in the conversation). Lastly selection of personal account, type and learning style is selectable by the user. A personal account selection is whether the assistant operates under the user's own name, or if it acts as if they are an independent real person (AI identity). The type is a selection between the assistant being associated with a single user, or a team. For example, a sales assistant may be responsive to the entire sales division, or a single sales representative. Learning style is a selection that determines how the assistant improves over time. This may be either through manual review of non-confident responses, versus automatic learning.

### III. System Embodiments

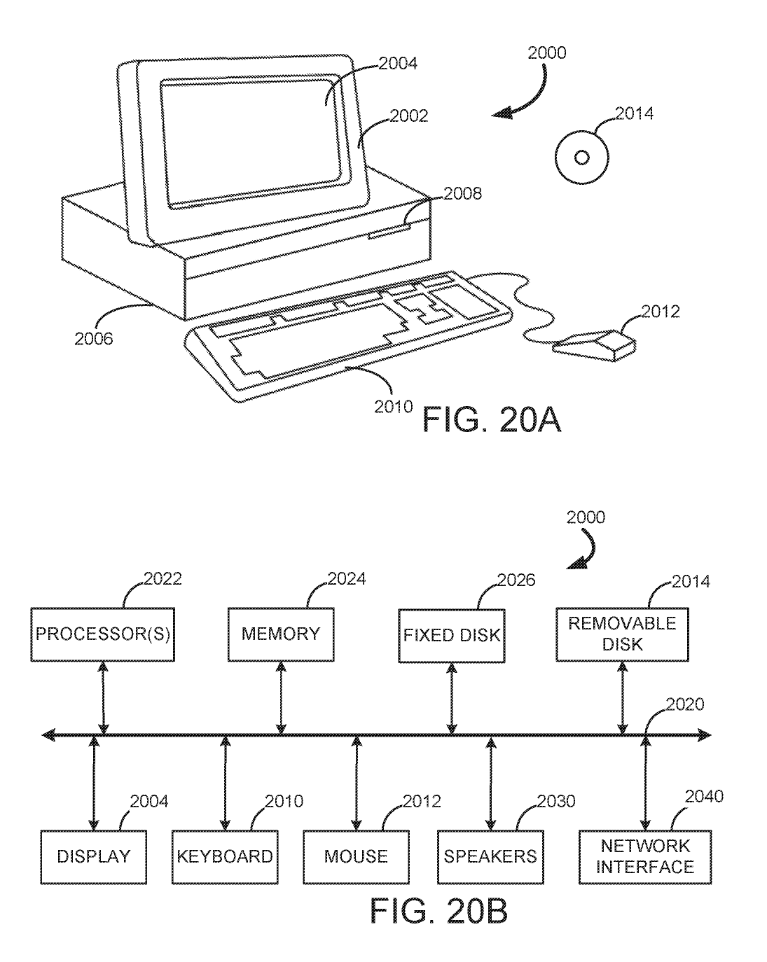

Now that the systems and methods for the conversation generation, dynamic messaging with variable replacements have been described, attention shall now be focused upon systems capable of executing the above functions. To facilitate this discussion, FIGS. 20A and 20B illustrate a Computer System 2000, which is suitable for implementing embodiments of the present invention. FIG. 20A shows one possible physical form of the Computer System 2000. Of course, the Computer System 2000 may have many physical forms ranging from a printed circuit board, an integrated circuit, and a small handheld device up to a huge super computer. Computer system 2000 may include a Monitor 2002, a Display 2004, a Housing 2006, a Disk Drive 2008, a Keyboard 2010, and a Mouse 2012. Disk 2014 is a computer-readable medium used to transfer data to and from Computer System 2000.

FIG. 20B is an example of a block diagram for Computer System 2000. Attached to System Bus 2020 are a wide variety of subsystems. Processor(s) 2022 (also referred to as central processing units, or CPUs) are coupled to storage devices, including Memory 2024. Memory 2024 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 2026 may also be coupled bi-directionally to the Processor 2022; it provides additional data storage capacity and may also include any of the computer-readable media described below. Fixed Disk 2026 may be used to store programs, data, and the like and is typically a secondary storage medium (such as a hard disk) that is slower than primary storage. It will be appreciated that the information retained within Fixed Disk 2026 may, in appropriate cases, be incorporated in standard fashion as virtual memory in Memory 2024. Removable Disk 2014 may take the form of any of the computer-readable media described below.

Processor 2022 is also coupled to a variety of input/output devices, such as Display 2004, Keyboard 2010, Mouse 2012 and Speakers 2030. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2022 optionally may be coupled to another computer or telecommunications network using Network Interface 2040. With such a Network Interface 2040, it is contemplated that the Processor 2022 might receive information from the network or might output information to the network in the course of performing the above-described dynamic messaging processes. Furthermore, method embodiments of the present invention may execute solely upon Processor 2022 or may execute over a network such as the Internet in conjunction with a remote CPU that shares a portion of the processing.

Software is typically stored in the non-volatile memory and/or the drive unit. Indeed, for large programs, it may not even be possible to store the entire program in the memory. Nevertheless, it should be understood that for software to run, if necessary, it is moved to a computer readable location appropriate for processing, and for illustrative purposes, that location is referred to as the memory in this disclosure. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

In operation, the computer system 2000 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is, here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The algorithms and displays presented herein are not inherently related to any particular computer or other apparatus. Various general-purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may, thus, be implemented using a variety of programming languages.

In alternative embodiments, the machine operates as a standalone device or may be connected (e.g., networked) to other machines. In a networked deployment, the machine may operate in the capacity of a server or a client machine in a client-server network environment or as a peer machine in a peer-to-peer (or distributed) network environment.

The machine may be a server computer, a client computer, a virtual machine, a personal computer (PC), a tablet PC, a laptop computer, a set-top box (STB), a personal digital assistant (PDA), a cellular telephone, an iPhone, a Blackberry, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computer implemented method for variable field replacement in templates used in a conversation between a target and an Artificial Intelligence (AI) messaging system comprising:
selecting a message template with variable fields;
analyzing customer and industry information;
determining objective state for the conversation;
identifying target information; and
performing entity replacement in the message template using customer, industry and target information; and
performing lexical replacement responsive to the objective state and industry information.

2. The method of claim 1, further comprising receiving a response.

3. The method of claim 2, further comprising classifying the response.

4. The method of claim 3, further comprising updating the objective state based upon the classification.

5. The method of claim 1, wherein the lexical replacement includes word substitution with synonyms tagged by industry type and objective state.

6. The method of claim 1, further comprising outputting the message template after entity and lexical replacement as a response.

7. The method of claim 1, further comprising outputting the message template after entity and lexical replacement for phrase packet selection.

8. The method of claim 1, further comprising outputting the message template after entity and lexical replacement for additional actions.

9. The method of claim 8, wherein the additional actions include accessing a third-party system to attach a document, make a purchase, modify a calendar, or auto-populate information.

10. The method of claim 1, wherein the entity replacement is responsive to a conversation library with hierarchical inheritance.

11. A computer implemented system for variable field replacement in templates used in a conversation between a target and an Artificial Intelligence (AI) messaging system comprising:
a database of message templates with variable fields, customer, target and industry information;
a dynamic messager with a processor for selecting a message template from the plurality of message templates;
a natural language processor for determining objective state for the conversation; and
a message builder for performing entity replacement in the message template using customer, industry and target information, and lexical replacement responsive to the objective state and industry information.

12. The system of claim 11, further comprising a messaging interface for receiving a response.

13. The system of claim 12, further comprising a classification engine for classifying the response.

14. The system of claim 13, wherein the natural language processor updates the objective state based upon the classification.

15. The system of claim 11, wherein the lexical replacement includes word substitution with synonyms tagged by industry type and objective state.

16. The system of claim 11, further comprising outputting the message template after entity and lexical replacement as a response.

17. The system of claim 11, wherein the message builder outputs the message template after entity and lexical replacement for phrase packet selection.

18. The system of claim 11, wherein the message builder outputs the message template after entity and lexical replacement for additional actions.

19. The system of claim 18, wherein the additional actions include accessing a third-party system to attach a document, make a purchase, modify a calendar, or auto-populate information.

20. The system of claim 11, wherein the entity replacement is responsive to a conversation library with hierarchical inheritance.
